(19) United States
(12) Patent Application Publication
(10) Pub. No.: US 2007/0071878 A1
(43) Pub. Date: Mar. 29, 2007

(54) METHOD FOR MAKING FROZEN GROUND MEAT CRUMBLES AND PRODUCT MADE THEREBY

(75) Inventors: Patrick H. Huebner, Windsor, CO (US); Timothy E. Goodmann, Windsor, CO (US); George E. McDonough, Windsor, CO (US); Hugo Irizarry, Fort Collins, CO (US)

Correspondence Address: SHERIDAN ROSS PC, 1560 BROADWAY, SUITE 1200, DENVER, CO, 80202, US

(73) Assignee: SWIFT & COMPANY, Greeley, CO (US)

(21) Appl. No.: 11/536,391

(22) Filed: Sep. 28, 2006

Related U.S. Application Data
(60) Provisional application No. 60/722,179, filed on Sep. 29, 2005.

(51) Int. Cl. A23L 1/31

(52) U.S. Cl. 426/646

(57) ABSTRACT

A method of producing meat crumbles is described. Meat crumbles are produced such that the individual crumbles maintain their separation through processing to the final product. When used by a consumer, the meat does not have to be directly handled before being placed into a cooking apparatus, thereby reducing the mess and potential bacterial infections associated with the excessive handling of meat products.

### CROSS REFERENCE TO RELATED APPLICATIONS

This application claims benefit of U.S. Provisional Patent Application Ser. No. 60/722,179, filed Sep. 29, 2005, which is herein incorporated by this reference in its entirety.

### FIELD OF THE INVENTION

The present invention relates to a process of producing meat crumbles. More specifically, the process creates meat crumbles that are not stuck together when packaged for shipment.

### BACKGROUND OF THE INVENTION

The processing of ground meat is not a new science. For years ground meat has been processed in a fashion where different ratios of lean meat and fat, have been blended together. The meat blend is then ground, comminuted, or reduced in size, and extruded using meat extrusion devices.

The problem with known methods of ground meat production is that the finished product is not as desirable as it could be to consumers. For example, when a consumer purchases ground meat and goes to cook that meat, they have to take that meat out of the package and handle it in order to prepare the meat the way they want to. If the meat is intended to be cooked in a skillet, i.e. for tacos, sloppy joes, or any other meal where the meat is cooked to a crumbled state, the user must typically handle and break up the meat from its original compacted state. The unfortunate side effect is that consumers of the final product have to deal with physically handling meat, portioning it to desired sizes, and potentially making a mess.

Therefore, a need exists for a finished meat product that does not require undesired handling or manipulation by the consumer to obtain desired size characteristics before cooking. Also, a method of producing this type of meat is necessary.

### SUMMARY OF INVENTION

It is thus one aspect of the present invention to provide a method of producing frozen ground meat crumbles. The ground meat crumbles are in a form that consumers would like to see when they are preparing the meat in a skillet, flat grill, microwave or the like.

As used herein “meat” is understood to be any one of beef, poultry, pork, lamb, fish, crustaceans, or the like. Also “meat” as used herein can generally include non-meat items such as vegetables, starch components, tofu, and/or soy-based products, alone or in combination with animal-derived portions.

In accordance with embodiments of the present invention, meat trimmings both lean and fat trimmings along with frozen or non-frozen materials are blended together with the presence of a coolant (CO₂, N₂, Argon, compressed air, any other cooling air or liquid). Bones and other various objects are removed from the meat. For instance, if any metal is present in the meat, a magnet or electromagnetic field is used to detect and separate the metal from the meat. Also bones can be removed from the meat according to known methods. The blend is put through a grinder plate where the meat can be ground up into various sizes. Although it is preferable to create meat crumbles of various sizes, one can easily produce meat crumbles of substantially the same size.

In the grinding step meat can be ground to a desired size giving the soon to be crumbles particle definition. The desired particle definition can be confirmed visually such that the difference between the fat and lean meat can be seen. Alternatively, the verification of particle size can depend on the temperature at which the meat is ground. Meat can go through the grinder at a temperature of about 25° F. to about 40° F. A more preferred temperature range is about 26° F. to about 35° F., with the most preferable temperature range being about 28° F. to about 33° F.

Rather than grinding the meat, any other comminution process can be performed. Comminution can include grinding, chopping, flaking, dicing, shredding, slicing, extruding, and the like. The purpose of the comminution step is to break or shape the meat into a preferred size and /or configuration.

Next, in accordance with embodiments of the present invention, the meat is sent to an extruder by some conveying means. In a simple example, the meat is conveyed in any suitable manner from the grinder to the extruder. Preferably the meat is transferred by a conveyer system. The conveyer system may incorporate the use of a belt to carry the meat from one step to the next. Alternatively, an auger may be used to transport the meat from step to step. Also, the meat may be pumped from step to step. Additionally, a porous sheet of material (e.g., metal, plastic, etc.) may have compressed air or CO₂, pushed out of the holes in the sheet to create a bed of air that the meat can be transported on. It is ideal to try and keep the temperature of the meat a low as possible during processing. Therefore, transportation systems that increase the temperature of and around the meat may not be the most preferred systems but still are possible. Transportation systems are not confined to carrying the meat between the grinding and extrusion step. The meat has to travel to many different steps and transportation systems can and typically need to be used to carry the meat from step to step. The same transportation system can be used throughout the entire meat producing process. Alternatively, a combination of transportation systems can also be used between different steps in the sequence to make the entire process more efficient.

In accordance with embodiments of the present invention, in the extrusion step, the meat may be formed into various finished sizes or the same size depending on the desired finished product. In the extrusion process the diameter and length of the crumbles is determined. The term diameter is used to describe the relative size of an individual meat crumble. It is usually the case that the meat crumbles have an irregular diameter and sometimes the meat crumbles are much longer than they are wider. Extrusion can be performed by pressing the meat through a screen or mesh or any type of die that lends shape to the meat. The screen may have openings of different sizes to create multi-sized meat crumbles. Typically crumbles having an irregular diameter of about 1/16″ to about ¼″ are preferred. This size of meat crumble allows users to cook the meat and eat it in manageable pieces. The extrusion step can be performed before the meat is blended and chilled, however alternative embodiments of the present invention utilize the extrusion step after the meat has been blended and chilled.

In one embodiment after extruding the meat, a freeze process is performed where at least one of liquid CO₂, liquid N₂, Argon, compressed air, Freon, and the like are utilized while the meat is blended inside of a known type of blender. A clamshell blender can be used that has two oppositely spinning axles with paddles/ribbons deposited thereon. The paddles/ribbons act to mix and blend the meat while the meat is simultaneously cooled with the above-mentioned chilling medium. The size of the blender typically only depends on the amount of meat that is desired to be processed. Sizes of blenders between about 125 lbs and about 10,000 lbs are currently known in the prior art and can be used in this step.

By quickly freezing the meat during the blending process individual meat crumbles are formed that do not freeze together with other meat crumbles like in the prior art. The chilling gas can be incorporated at various temperatures and in various quantities depending on the type of meat being processed and the desired final product. For example, in one embodiment, if the meat is a beef product, the chilling is preferably performed by introducing liquid CO₂ into the blender as the chilling gas. The beef is blended for preferably about 10 minutes in the presence of the CO₂/refrigerant The meat is preferably extruded to a diameter of about ⅛″ to about ⅜ before it is introduced into the blender and frozen. The temperatures present inside the blender are preferably in the range of about 25° F. and about 40° F.

Another embodiment of the invention is chilling and blending the raw material prior to extruding through a positive displacement pump and subsequently through a sizing and portioning device.

Alternatively, in accordance with embodiments of the present invention, the meat may be frozen by employing a fluidized bed that passes cold air chilled by some sort of refrigerant (ammonia, Freon, etc.) or a liquid CO₂ or N₂. The meat is frozen such that that previously established particle size and definition is maintained by freezing each particle. As previously mentioned, the meat can be blended and frozen or it can be just frozen, so long as individual particle definition is preserved.

In one embodiment, after the meat has been frozen and blended sufficiently, inclusions can be added in a dried, wet, and/or frozen state, (preferably frozen) for instance, peppers, onions, salt or any other dried inclusion. The inclusions may also be added during the blending and chilling process. Alternatively, liquid inclusions (e.g., sloppy joe mix, tomato paste, etc.) may be added after the blend of the different meats but before the grinding step. Another way to add inclusions is by spraying the meat according to known methods with a desired inclusion spray (e.g., sauces, gravies, antioxidants and the like.)

In another embodiment of the present invention, competitive bacteria are included in or with the meat. These competitive bacteria, known as euhygienic bacteria, are non-pathogenic and/or non-spoilage bacteria. They competitively inhibit and/or exclude the growth of pathogenic and spoilage bacteria. The use of euhygienic bacteria in the present invention generates little, if any, appreciable malodors or discolorations of food products. In one embodiment of the present invention, euhygienic bacteria are preferably facultative, sacrophilic, gram positive bacteria, and morel preferably bacteria of the genus Lactobacillus. By inoculating the meat (prior to or after the formation of meat crumbles) with friendly bacteria, the shelf life of the meat is greatly increased without compromising the quality of the meat or the safety of the consumer. The bacteria can be incorporated with the meat crumbles at various stages during the production process. For instance they can be added after the blending step and before the grinding step with the liquid inclusions. Alternatively, the bacteria can be added with the dried inclusions during or after the blending process.

After blending, in accordance with embodiments of the invention, the meat can be packaged using a vertical form-fill-seal bagger or some other type of bagging method. The portions of meat that are bagged can vary depending on various requirements and desires. Large quantities can be prepared for commercial and restaurant settings whereas smaller portions can be prepared for residential or single serving use. The meat can be bagged by hand with workers filling bags with so many scoops of the finished meat product. In a preferred embodiment, however, a vertical form filled seal bagger is used that can automatically weigh out portions and divide them up among various bags to ensure that the final products are somewhat uniformly prepared. The final product is preferably placed into a resealable bag that is easily opened by a consumer. A proper bag ensures that the consumer does not have to handle the meat crumbles before they are placed into the desired cooking apparatus.

Once the meat crumbles are partitioned and bagged the bags are boxed into cases for delivery. The boxes can be distributed among different pallets and sent into inventory. Then the finished product is either delivered to distributors, consumers, or kept in a storage area of −20 degrees F. to +25 degrees F. until shipment is desired.

By creating a product that does not require direct consumer contact before cooking the meat has a lesser chance of picking up harmful bacteria before it is cooked. Additionally, typical messes that are associated with handling previous meat products are avoided. The consumer does not have to deal with blood (meat juice) in the packaging as well as on their hands. Messes that were once an issue are virtually non-existent with embodiments of the present invention.

One aspect of the present invention is directed to a method for preparing a meat containing meal without the need to manually touch the meat product. Such a method, in one embodiment, is as follows: (a) take a package containing the meat product produced according to embodiments of the present invention out of a freezer or other storage facility; (b) open the package and pour the meat product into a cooking apparatus without directly contacting the meat product; and (c) reseal the package, if the container can be resealed, and place the package along with the remaining meat product, if any, back into the storage facility.

These and other advantages will be apparent from the disclosure of the invention(s) contained herein. The above-described embodiments and configurations are neither complete nor exhaustive. As will be appreciated, other embodiments of the invention are possible using, alone or in combination, one or more of the features set forth above or described in detail below.

### BRIEF DESCRIPTION OF THE DRAWINGS

FIG. 1 is a block diagram depicting a method of producing meat crumbles in accordance with one embodiment of the present invention;

FIG. 2 shows coarse ground lean trimmings in accordance with another embodiment of the present invention;

FIG. 3 shows a sample meat product after a final grind in accordance with yet another embodiment of the present invention;

FIG. 4 shows a sample meat product after extrusion in accordance with a further embodiment of the present invention;

FIG. 5A shows a top view of an extruder used in accordance with embodiments of the present invention;

FIG. 5B shows a side view of an extruder used in accordance with embodiments of the present invention;

FIG. 5C shows an end view of an extruder used in accordance with embodiments of the present invention;

FIG. 6 shows a machine used in the freezing and blending step in accordance with yet a further embodiment of the present invention;

FIG. 7 shows the inside of a “clamshell” blender that is used in accordance with still another embodiment of the present invention;

FIG. 8 shows a measuring device and the crumbled meat product during the freeze and blending step in accordance with still a further embodiment of the present invention;

FIG. 9 shows the crumbled meat product during the freeze and blending step in accordance with a different embodiment of the present invention; and

FIG. 10 shows the bagging step in accordance with embodiments of the present invention.

### DETAILED DESCRIPTION

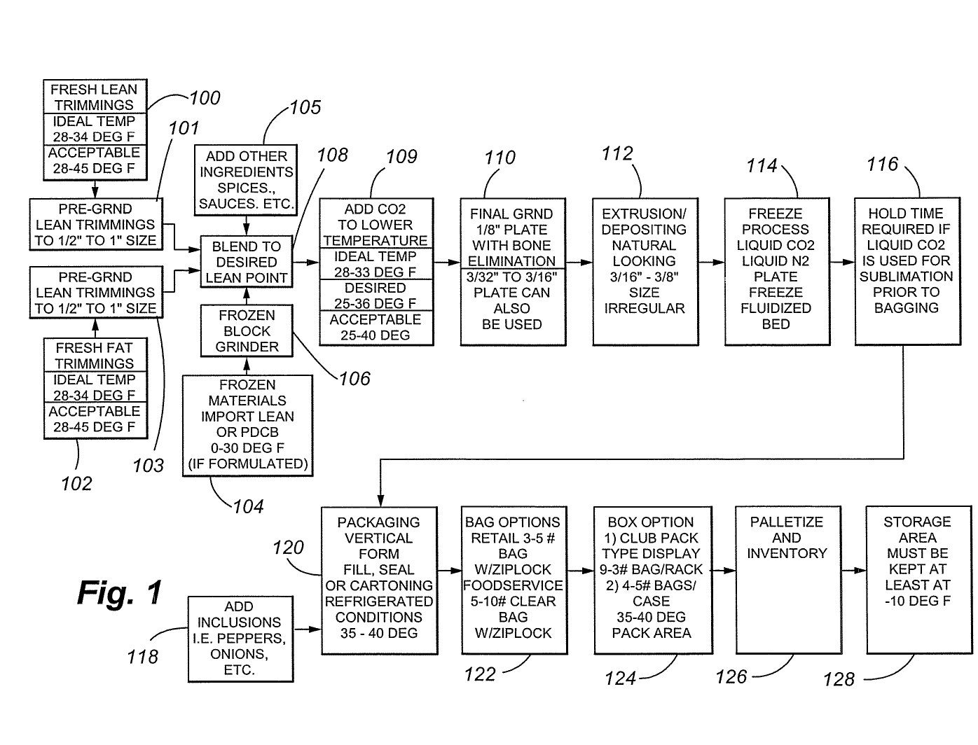

Referring initially to FIG. 1, a method of producing frozen ground meat crumbles is described in accordance with embodiments of the present invention. Although well-suited for processing meat crumbles made of beef, poultry, port, lamb, fish, crustaceans, and the like, the present invention can be used to process non-meat products such as vegetables, starch components, tofu, and/or soy-based products.

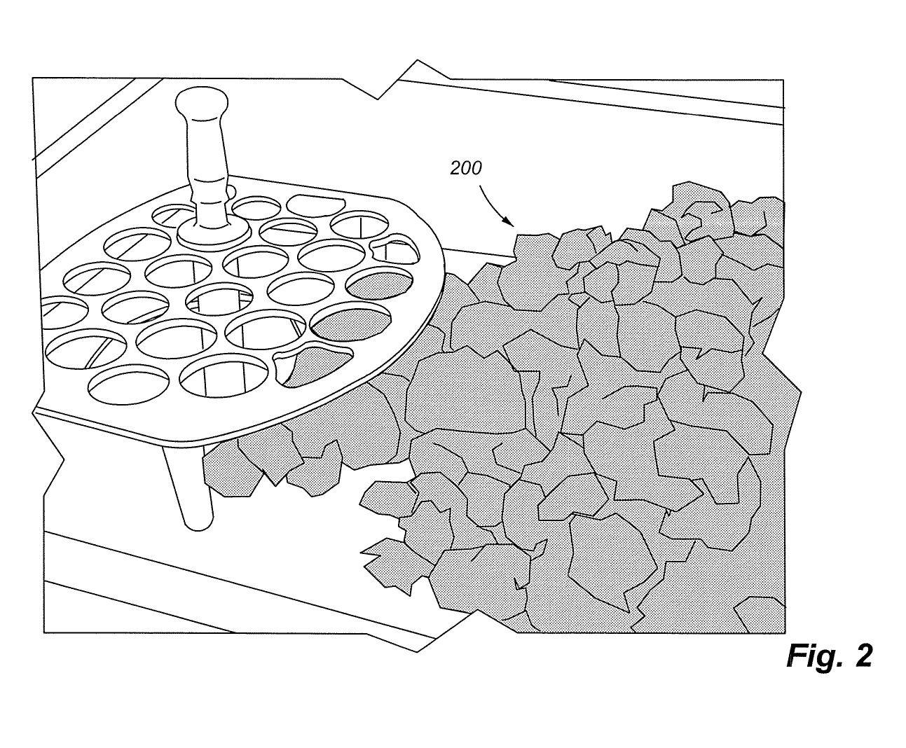

In step 100, fresh lean trimmings 200 are provided. In step 101 the lean trimmings 200 are pre-ground to sizes ranging from about ½″ to about 2″. A more preferable size of the ground lean trimmings 200 is between about ½″ and about 1″, with the most preferable size being between about ½″ and about ¾″ as can be seen in FIG. 2. In step 105, ingredients including sauces like tomato paste, sloppy joe mix, and other spices can be added to the lean trimmings. In particular additives such as antioxidants, antimicrobials, flavor enhancers, and/or sauces can be integrated with the meat.

Additionally, in step 102, coarse fat trimmings are provided. In step 103 these trimmings can be pre-ground to sizes commensurate with the size of the course ground lean trimmings provided in steps 100 and 101. Temperatures of both the coarse ground lean trimmings and the coarse ground fat trimmings can range between approximately 28° F. and 45° F. with a preferred temperature of the trimmings being in the range of about 28° F. and about 34° F.

In step 104 frozen materials can be integrated into the meat blend. The frozen materials may be incorporated as hard frozen materials, frozen tempered materials, all fresh materials, or if preferred a mix of both fresh and frozen materials. In a preferred embodiment, frozen materials comprise approximately 20% of the mix and fresh materials comprise approximately 80% of the mix with the fresh materials being at about 32° F. and the frozen materials being at about 25° F. These materials can be cold blended, therefore requiring less CO₂ or other refrigerants in later steps to freeze. Step 104 can be performed between the temperatures of 0° F. and 30° F., in contrast to the operating temperature ranges of steps 100 and 102. The mixed materials are combined in Step 106 by use of a frozen block grinder.

Once all of the trimmings and frozen material are ready to be combined they are conveyed to a blending step, step 108. The blending step 108 is performed to achieve a desired combination of components, typically requiring from about 30 seconds to up to about 10 minutes, but preferably for about four minutes at approximately 25° F. to 40° F. In a preferred embodiment, the temperature is held between approximately 26° F. and 35° F. In the most preferred embodiment, the temperature in the blending step 108 is between about 28° F. and about 33° F. The length of time and temperature at which step 108 is performed depends on the type of meat that is being processed as well as the desired consistency of the final product.

The addition of CO₂ in step 109 to perform a cold blending step can help to create particle definition before the final grind, extrusion, and freezing steps are performed later. By cooling the meat down before it is ground, blended, and chilled, less refrigerant may be required in later steps of the process. CO₂ can be added in any suitable manner to achieve the objective of generating an at least partially frozen ground meat portion of a desired size. The purpose of the CO₂ is to establish a desired temperature of the blend so that the final grinder will perform at optimum conditions. Amounts of CO₂ (coolant) required depend on the initial temperature of the product (i.e., whether a portion of the blend was frozen material), size of the batch, etc.

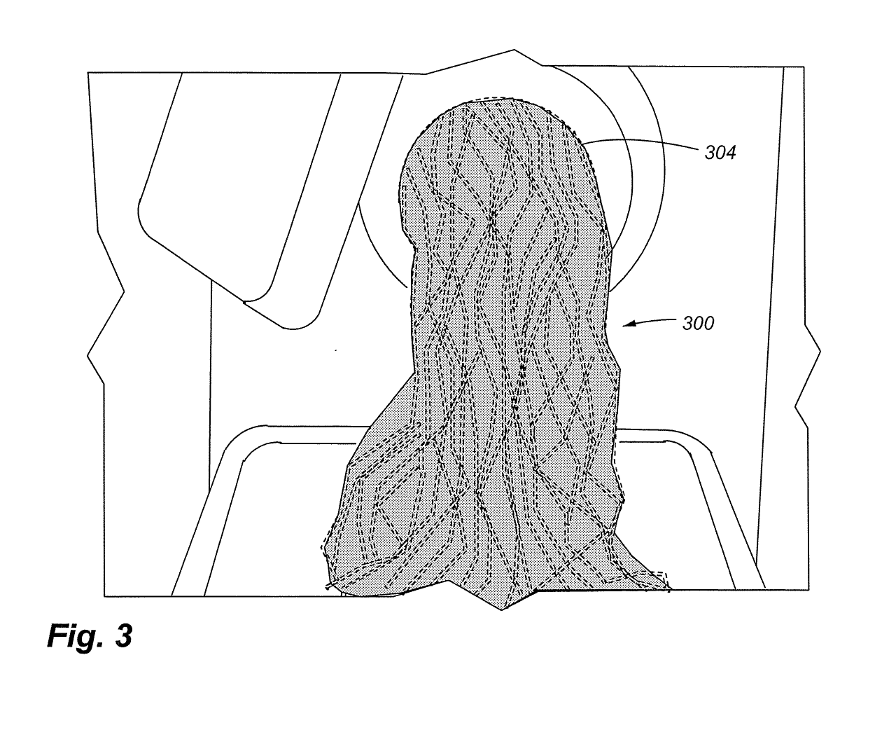

In step 110, the blended meat 300 (now combined coarse fat trimmings, coarse lean trimmings, and/or frozen materials) is sent through a final grind plate 304. In this step, any residual bones and other foreign objects within the meat are eliminated. Metal can be removed from the meat by using a metal detector, a magnetic field or other known metal-detecting/removal methods/devices. Likewise bones are removed according to known methods. Grinding is done in a known fashion and byproducts of the grinding step can be seen in FIG. 3.

Instead of simply grinding the meat any other comminution processes can be performed. For example, the meat can be ground, flaked, diced, sliced or shredded. Certain comminution processes may be more desirable for different types of meat. In U.S. Pat. No. 4,804,551 to Matthews et al. entitled, “Manufacture of Meat Based Products” method of comminuting meats to a desired particle size is described.

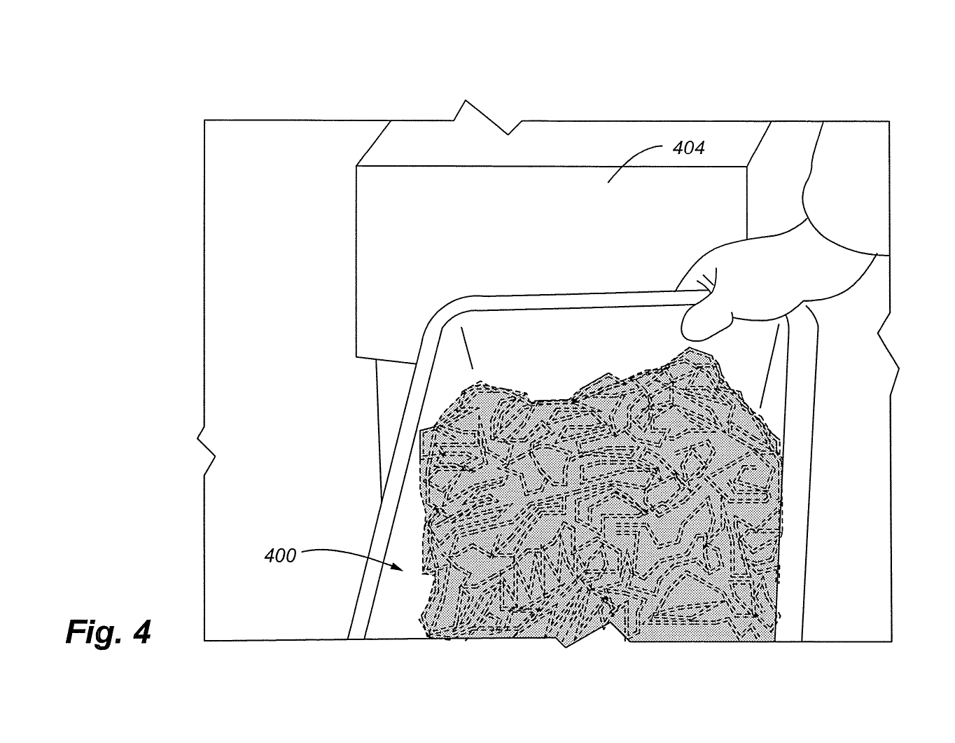

Thereafter, the meat 400 is extruded into a desired size in step 112. Step 112 corresponds to FIG. 4 where the meat 400 is extruded to a preferably irregular diameter of approximately 1/16″ to ½″. In a more preferred embodiment, the meat 400 is extruded to sizes of about 3/16″ to about ⅜″ in irregular diameter. Typically meat crumbles of irregular size and shape are desired. Therefore, the use of the term “irregular diameter” is used to define the relative size of the meat crumbles. “Irregular diameter” can also describe a substantially spherical or round meat crumble. Certain circumstances may exist where a more uniformly shaped meat crumble is desired rather than the traditional non-uniform crumbles. Also, “irregular diameter” describes a meat crumble that does not necessarily have a circular disposition. Some meat crumbles may be much longer than they are wide and the term “irregular diameter” is used to describe the size of these meat crumbles as well.

Preferably, the meat crumbles have characteristics similar to those of crumbled, browned meat a consumer would prepare in a browning skillet or similar cooking apparatus. For example, the size of the crumbles would vary, with the largest being no more than about 1″ and various sizes smaller making up the remainder.

The extrusion process 112 can be performed by passing the meat 400 through an extruder 404. Also the meat can be pushed through a screen or membrane or other sizing device, thereby partitioning the meat into various sizes. Screens having uniform sized holes can be used to create substantially uniformly sized meat crumbles. On the other hand, a screen with non-uniform sized openings can be used to create particles of various sizes.

In one embodiment the extruder 404 used to create the meat 400 is a pasta like extruder that simply pushes the meat out of holes under pressure then cuts the meat at a predetermined length using a knife or the like. However, extruding meat 400 with this particular type of extruder may result in an unsatisfactory amount of fines. The fines may be added back to the meat mixture and can therefore be recycled that way but this requires additional steps that may not be preferred in some circumstances. Other solutions would be to eliminate/limit the creation of fines during the extrusion step.

In another embodiment, the extruder 404 used to create meat 400 of irregular diameter and size can be one similar to an extruder manufactured by Heat and Control™ known as the Nugget Former. The Nugget Former manufactured by Heat and Control™ is generally designed for use in extruding meat having a number of other ingredients (e.g., spices, taco seasoning, etc.) therein. The addition of other ingredients changes the consistency of beef, for example, such that the extruder makes relatively irregularly sized pieces of meat. However, when use of the Nugget Former is attempted with raw beef, for example, the Nugget Former does not function properly. The consistency of pure raw beef is such that the Nugget Former gets backed-up and meat is not extruded out of all holes of the Nugget Former evenly thus decreasing yield.

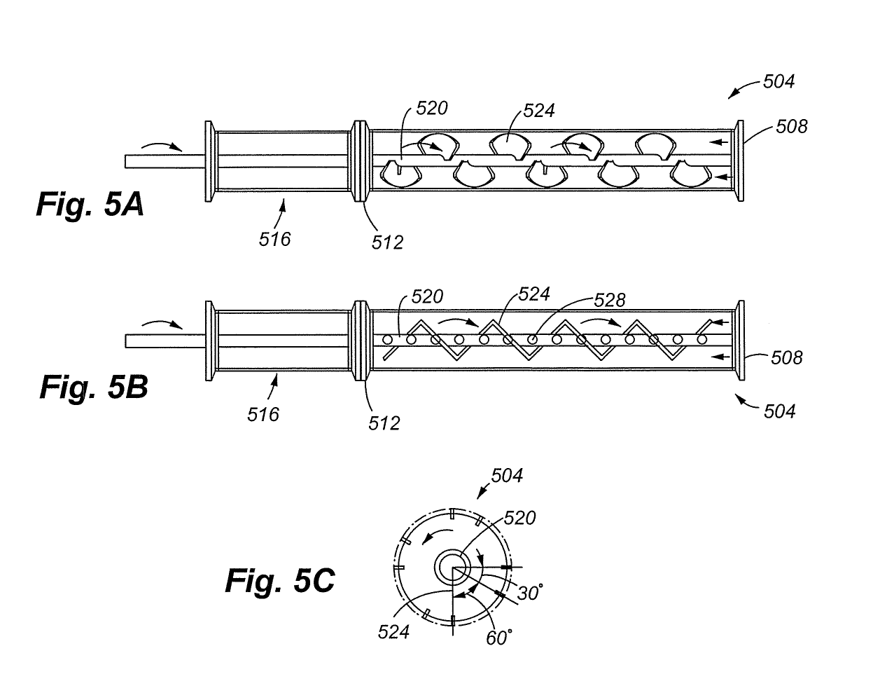

To this end, one embodiment of the present invention provides an improved extruder design as can be seen in FIGS. 5A-C. The improved extruder 504 is cylindrical in shape and has a first end 508 and a second end 512. Meat is input to the extruder 504 at the first end 508 and the second end of the extruder 512 is connected to a drive assembly 516. The drive assembly 516 causes a shaft 520 within the extruder 504 to rotate. A number of scrapers or paddles 524 are connected to the shaft 520. Movement of the paddles 524 achieves two functions. First, movement of the paddles 524 causes the meat within the extruder 504 to be pushed from the second end 512 toward the first end 508 to counter the pumping of the meat into the extruder from the first end 508. Second, movement of the paddles 524 applies pressure to the meat within the extruder 504 thereby forcing the meat out of holes 528 located on the side of the extruder 504. As meat is forced out of a hole 528 a paddle 524 will be passed across the hole 528 thereby cutting the meat into individual chunks.

The holes 528 can be of various sizes and configurations to achieve meat chunks of an irregular size and shape. For example, each hole 528 in the extruder 504 may have a unique shape that causes meat to be extruded therefrom differently. The size of the holes 528 may vary between about 3/16″ to about ½″ in diameter. The shapes of the holes 528 may vary between round, oblong, square, cloverleaf, diamond, or combinations thereof. The extruder 504 does not necessarily have to have identical holes 528 across it's side but rather could have a mixture of shapes and sizes for each hole 529. Additionally, the paddles 524 may be spaced apart at different angular intervals thus causing the meat to be pushed out to different sizes before it is cut off at the hole 528. For example, the angle between a first and second paddle may be 30 degrees and the angle between the second and a third paddle may be 60 degrees. Therefore, meat will be pressed out to a greater length between the second and third paddles. The length of the meat strand or crumble may also be dictated by the speed of rotation of the paddles 524.

In accordance with another embodiment, cutting blades may be placed on the outside of the extruder 504 instead of or in addition to the inner paddle assembly. The blades on the outside can be used to cut the meat off at the hole 528 from the outside of the extruder 504 instead of or in addition to being cut from the inside. The inner and outer blades/paddles may also cut the meat simultaneously on each side of the holes 528 thus resulting in a chunk of meat that is shaped similar to the hole 528.

As can be appreciated, paddles 524 are not the only type of mechanism that can be used to coerce meat through the extruder and cut the meat off at the hole 528. Rather, other ribbon or screw assemblies can be employed that will achieve creation of irregularly shaped meat chunks.

In other embodiments, irregularly shaped meat crumbles could be made by first freezing a larger portion of meat then shattering the meat with a sudden impact from a blunt object. For example, a sheet of meat may be created then frozen. Thereafter, the sheet of meat could be impacted with a hammer causing chips of meat to be produced.

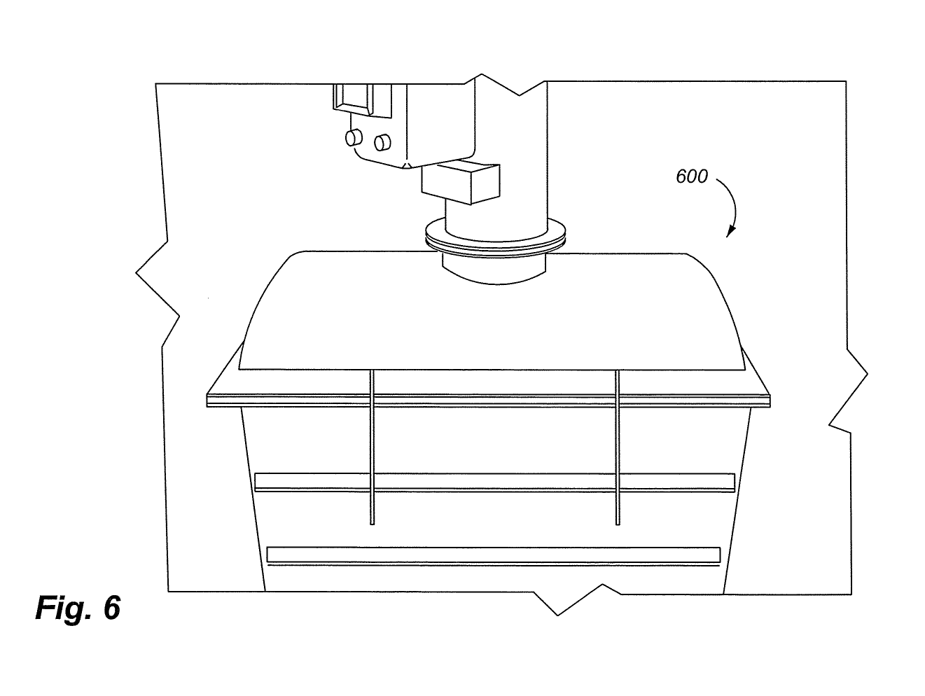

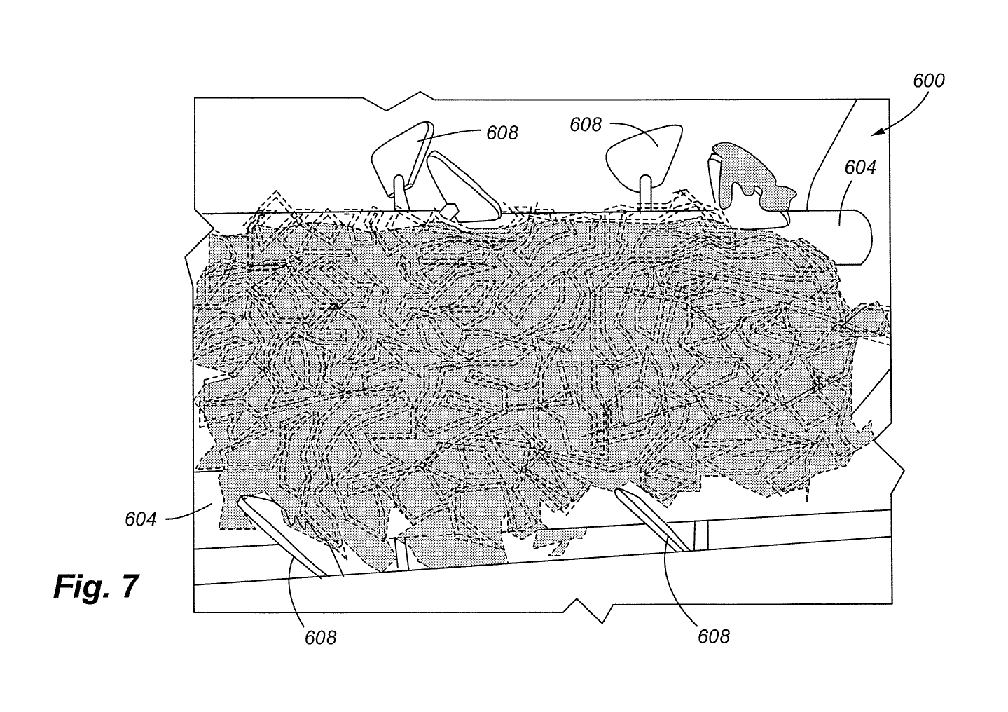

In step 114, the meat is processed to establish particle size. For instance, a method incorporating a fluidized bed can be used to establish particle size and freeze the meat particles using multiple refrigerant methods (ammonia, Freon, etc.) or a liquid CO₂ or N₂. Alternatively, the meat can be blended and frozen inside of a clamshell blender 600 for instance. An example of a clamshell blender can be seen in FIGS. 6 and 7. In one embodiment the blender 600 that is used has two rotating barrels 604 with paddles/ribbons 608 extending therefrom.

Simultaneously, in one embodiment of the present invention, the meat is treated with a coolant (i.e. CO₂, N₂, Argon, compressed air, Freon, ammonia, or any other known refrigerant). In accordance with embodiments of the invention, the meat is frozen in a controlled manner as it is blended. Temperatures present within the blender during this step can range between about −40° F. and about 15° F., where the range is preferably between about −40° F. and about −10° F. By quickly freezing the meat in this step, the meat particles that were created in the extrusion step are frozen as separate particles and maintain their solid definition. More precisely, the meat pieces are frozen separately during the blending process in order to maintain individual meat crumbles, rather than freezing many meat particles together into clusters or clumps. By freezing the meat pieces into individual crumbles, the meat can be packaged and be ready to be poured directly into a cooking apparatus like a skillet, frying pan, pot, and the like. When the meat crumbles are used they do not have to be directly handled by the user prior to cooking. The user can simply open the bag of meat crumbles and pour out a desired amount of the product.

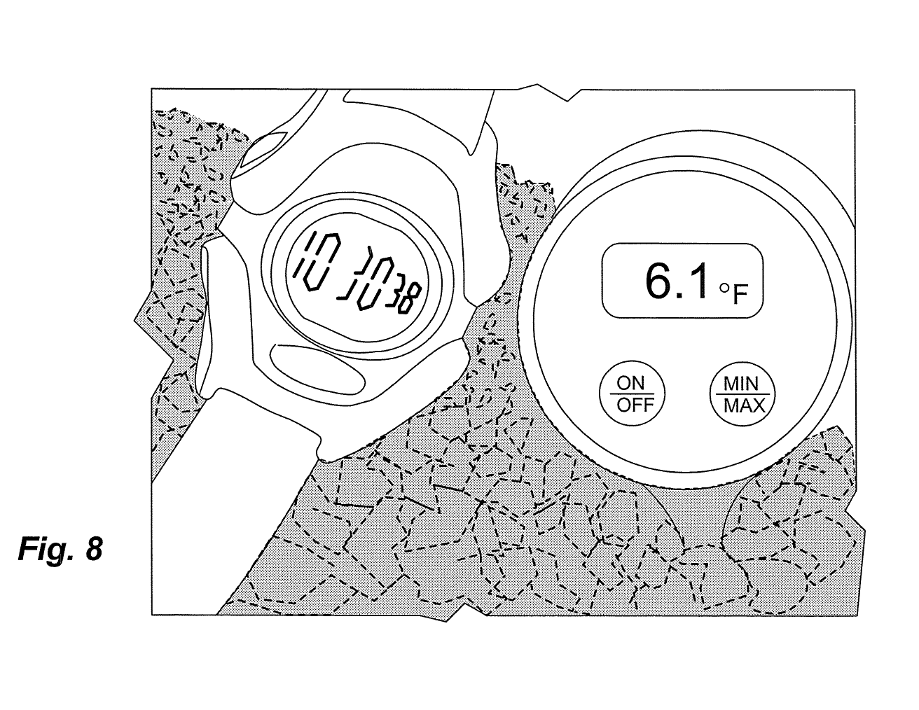

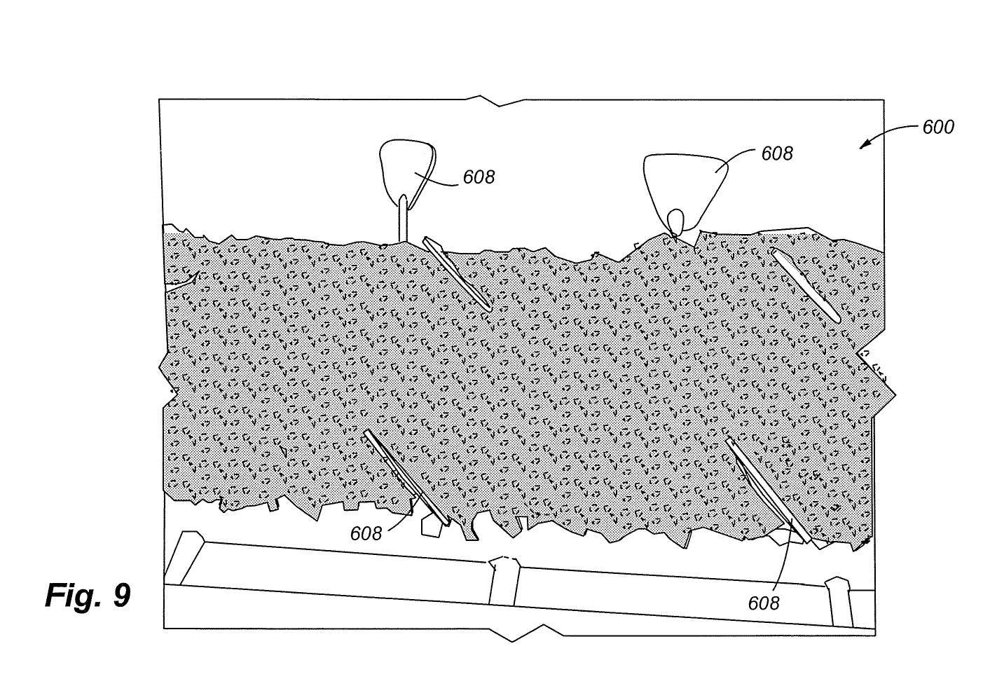

The amount of time that the meat is blended and frozen depends on the type and size of the meat crumble that is being processed as well as the desired final product. The blending step is generally performed until the meat particles have some adhesion to other particles as well as the blender 600 as can be seen in FIG. 9. As can be seen in FIG. 8, in step 116 the hold time required is approximately 10 minutes and 30 seconds if liquid CO₂ is used for sublimation prior to bagging. Excessive blending time or over freezing in step 116 causes the crumbles to act like gravel, rubbing on the surface of each other which reduces the size of the crumble, thereby creating a meat powder. One of the inventive aspects of the present invention is that this step is performed in a controlled manner so as to maintain a desirable finished product. If it is too hot (not enough coolant is used) excessive clumping of the meat occurs. Also if the freezing process is not performed long enough then the final product is not in the form of individual meat crumbles and is not very appealing to consumers.

It should be noted that the freeze and blending process, steps 114 and 116 can be performed before the extrusion process step 112. This all depends on the size and shape of the particles desired. If the blending and freezing process is performed before the extrusion process, then the frozen meat pieces are passed through an extruder, screen, and/or membrane to create a desired crumble size.

In step 118 inclusions are added to the now frozen meat crumbles. Typically non-meat frozen inclusions are added after the meat has been frozen and blended into crumbles. These inclusions can include vegetables, starch components, salt, seasoning, or any other dried substance. Additionally, the meat can be treated with a spray or different type of flavoring known in the art. In U.S. Pat. No. 6,054,154 to Wang entitled, “Method for Coating a Whole Meat Muscle Product with a Powdered Mixture” a method that can be used to coat the meat after blending is described. Different flavors and ingredients can be added at various points in the production process to enhance the final product.

Additionally, the frozen meat crumbles may be subjected to an ice glazing. In such a step the meat crumbles are run through a mist of water and broth that freezes around the meat crumble and creates a thin protective layer for the meat. The layer of ice protects the meat from additional moisture that will eventually be generated in the packaging while the meat waits to be purchased.

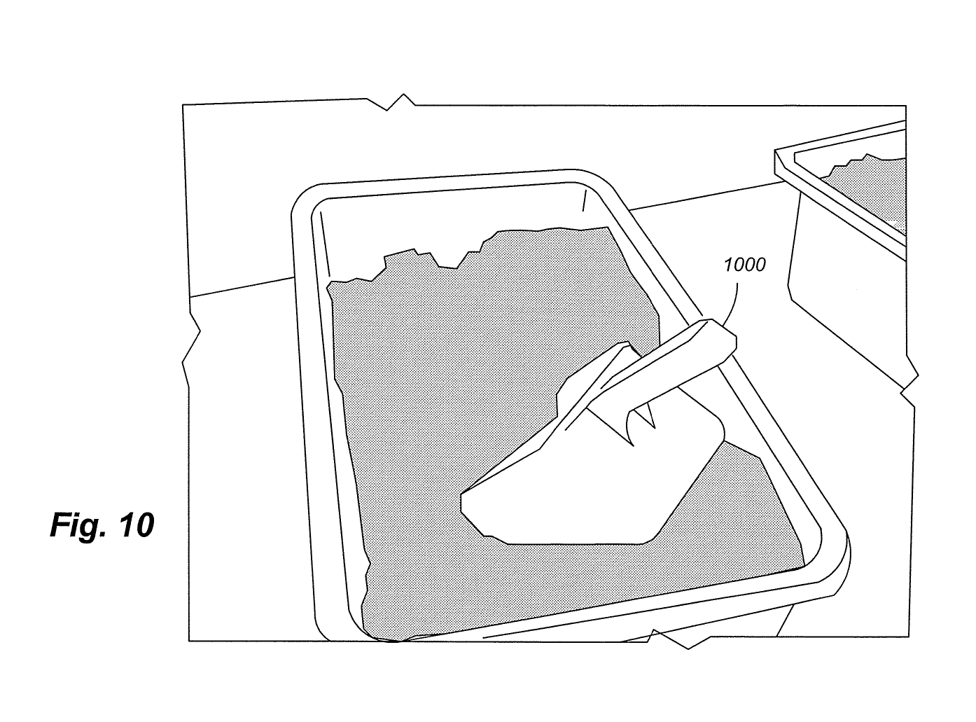

In step 120 the meat, with any inclusions, is sent to packaging. Packaging can be simply done by the use of a scoop 1000 and bag method as seen in FIG. 10. In a preferred embodiment, the meat is packaged with a vertical form-fill-seal bagger that automatically weighs and portions the product. Thereafter, the product is sealed into a desired bag, preferably a freezer safe bag, and more preferably one with an easy, reclosable seal feature. Preferably the container is designed such that the consumer can open and close the bag without having to permanently break the seal. The bag can be any type of container known in the art including retail bags with a zip-lock seal, clear foodservice bags with a zip-lock seal, and the like. The container options vary and may be chosen in step 122 depending on the end application or specification of the consumer. The container may also contain properties which inhibit or retard the rate at which the meat crumbles thaw when subjected to non-refrigerated conditions. For instance, insulated packaging could be used to ensure that the meat particles do not thaw during transport before they are used. Various types of insulated packaging include, foam, Styrofoam, urethane, any type of insulating polymer, and the like. The bagging step should be performed at temperatures that do not allow the meat crumbles to thaw and preferably should not exceed a range from about 26° F. to about 35° F.

In an alternative embodiment, the meat may be placed in the package then the air within the package may be removed. After the air is removed a gas such as Nitrogen or the like can be inserted into the bag. The inserted gas can act as a preservative that helps the meat stay fresh for a longer amount of time.

In step 124 the bagged meat can be boxed for display. It is acceptable to sell meat crumbles in the bag, however, boxing the crumbles for display in a retail store increases the image and ability to sell products. Also, the bags can be boxed into cases. Like the bagging step, the boxing step should be performed in refrigerated conditions where temperatures do not exceed a range from about 26° F. to about 35° F. The boxed meat crumbles are then palletized and sent into inventory in step 126. Thereafter, in step 128, the product may be shipped to the consumer, to a distributor, or kept in a storage place that is −20° F. to +25° F. to ensure that the meat crumbles do not thaw.

Advantages offered by embodiments of the present invention include the fact that consumers do not have to directly handle the meat before it is prepared. By decreasing the number of times the meat is handled, the likelihood of passing undesired bacteria to the meat is decreased. Unfortunately there still exists some chance that the meat can become infected with various forms of bacteria. In an effort to preclude these bacteria from spoiling and ruining the meat produced according to embodiments of the present invention, an effective amount of euhygenic bacteria can be incorporated in the meat crumbles. Methods of preserving food products by inoculation with an effective amount of euhygenic non-pathogenic, non-spoilage bacteria are described in several U.S. patents including: U.S. Pat. No. 6,569,474 to Clayton et al. entitled, “System for preserving food products”, U.S. Pat. No. 6,287,610 to Bowling et al. entitled, “Method for increasing the tenderness of a meat product”, U.S. Pat. No. 6,039,984 to Bowling et al. entitled, “Method for treating a food processing facility”, and U.S. Pat. No. 5,869,113 to Clayton et al. entitled “Method for preserved food products and food products made thereby”.

Throughout the above-described process the meat needs to travel from one step to the next. This can be facilitated by having a worker or workers simply carry the meat in bins from one step to the next step. However, a more efficient method of transportation is desired in larger scale meat production processes. The use of a conveyer belt system can move the meat from step to step. Alternatively, the meat can be pumped from step to step. Preferably, an auger can be used to move the meat from station to station. The use of an auger is preferred because it tends not to increase the temperature of the meat like pumping does. Any transportation system can be used alone or in combination with other systems throughout the production process. It may be desirable to have a conveyer belt move meat from one step to a second step and have an auger move the meat from the second step to a third step.

Various steps can be preformed in different combinations or in different sequences than those described above. Those skilled in the art will recognize that inventive aspects of the present invention can be extended to different techniques used in different applications. One novel aspect of the present invention is that it provides a clean, convenient, consumer-friendly meat product to the end user. Rather than having ground meat packaged and compressed together the present invention provides a frozen, free-flowing product that is ready to cook straight out of the bag without direct handling. The meat particles are not compressed together because they were frozen during the blending process thereby creating individual frozen particles. Current techniques prior to this invention have processed meat, extruded it, then combined meat pieces together as a single unit. A drawback to previous production methods is that consumers had to get their hands dirty and potentially create more of a mess in their kitchen by opening and dealing with bloody meat products. Also, the present invention reduces the chances of harmful bacteria being presented to the meat.

The present invention, in various embodiments, includes components, methods, processes, systems and/or apparatus substantially as depicted and described herein, including various embodiments, sub combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for producing meat crumbles comprising:
a) providing meat comprising at least one of fat trimmings, lean trimmings, and frozen meat materials;
b) grinding the meat, wherein bones and other foreign objects have been removed from the meat;
c) extruding the meat to create meat crumbles having a predetermined size and individual definition; and
d) freezing the meat in the presence of a coolant for a predetermined amount of time such that the meat particles maintain their individual definition.

2. The method of claim 1 further comprising:
a) adding inclusions to the meat.

3. The method of claim 2, wherein the adding inclusions step is performed after the blending step.

4. The method of claim 1, wherein the temperature is between about 25° F. and about 40° F. while the grinding step is performed.

5. The method of claim 1, wherein the coolant is at least one of N₂, Argon, air impingement, Freon, and ammonia.

6. The method of claim 1, wherein the coolant is CO₂.

7. The method of claim 1, wherein the predetermined amount of time is about 10 minutes.

8. The method of claim 1, further comprising:
a1) before the grinding step, initially blending the meat and adding a coolant to lower the temperature of the meat.

9. The method of claim 8, wherein the temperature is between about 25° F. and about 40° F. during the initial blending step.

10. The method of claim 1, wherein the meat is at least one of beef, poultry, pork, lamb, fish, crustaceans, or the like.

11. The method of claim 1, wherein the meat is inoculated with an effective amount of non-spoilage and non-pathogenic bacteria effective to competitively inhibit the growth of pathogenic and spoilage bacteria.

12. The method of claim 1, wherein the predetermined size of the meat crumbles is between about 1/16″ to about ½″.

13. Meat crumbles made by a process comprising the steps of:
a) providing meat comprising at least one of fat trimmings, lean trimmings, and frozen meat materials;
b) removing foreign objects from the meat;
c) grinding the meat;
d) extruding the meat to create meat crumbles having a predetermined size and individual definition; and
e) freezing the meat in the presence of a coolant for a predetermined amount of time such that the meat particles maintain their individual definition.

14. The meat crumbles of claim 13, wherein the predetermined size of the meat crumbles is between about 1/16″ to about ½″.

15. The meat crumbles of claim 13, wherein the predetermined size of the meat crumbles is between about ⅛″ to about ⅜″.

16. The meat crumbles of claim 13, wherein the meat is at least one of beef, poultry, pork, lamb, fish, crustaceans or the like.

17. The meat crumbles of claim 13, wherein the meat is inoculated with an effective amount of non-spoilage and non-pathogenic bacteria effective to competitively inhibit the growth of pathogenic and spoilage bacteria.

18. The meat crumbles of claim 13, wherein the coolant used in the blending step is at least one of CO₂, N₂, Argon, air impingement, Freon, and ammonia.

19. A method for preparing meat crumbles comprising:
a) opening a container of meat crumbles, wherein the meat crumbles have an irregular diameter of between about 1/16″ and about ½″, and wherein the meat crumbles are individually defined.
b) without directly touching the meat crumbles, pouring the meat crumbles from the container into a cooking apparatus.

20. The method of claim 19, wherein the meat crumbles have an irregular diameter of between about ⅛″ and about ⅜″.
